(19) United States
(12) Patent Application Publication
(10) Pub. No.: US 2025/0114698 A1
(43) Pub. Date: Apr. 10, 2025

(54) GAMING MACHINE AND METHOD WITH BASE GAME CONTINUATION FEATURE

(71) Applicant: Everi Games Inc., Austin, TX (US)

(72) Inventors: Jennifer Skaggs, Reno, NV (US); Juan Mariscal, Las Vegas, NV (US); Jesse Schuss, Reno, NV (US)

(21) Appl. No.: 18/904,055

(22) Filed: Oct. 1, 2024

Related U.S. Application Data
(60) Provisional application No. 63/543,060, filed on Oct. 7, 2023.

(51) Int. Cl. A63F 13/493

(52) U.S. Cl. CPC A63F 13/493

(57) ABSTRACT

A gaming machine along with a method, and program product are disclosed for operating the gaming machine. A gaming interface is displayed including an animated game element, a start button, and a claim prize button in a deactivated state. An initial game round has a first small chance of a total loss and a second larger chance of an increase in credits, conducting the initial game round, and displaying a result of the initial game round including a total credit prize. Responsive to the initial game round resulting in an increase in credits, the start button is changed to a continuation button, and the claim prize button is activated.

### CROSS-REFERENCE TO RELATED APPLICATION

This application claims the benefit, under 35 U.S.C. § 119(e), of U.S. Provisional Patent App. No. 63/543,060 filed Oct. 7, 2023 and entitled “Gaming Machine and Method With Base Game Continuation Feature,” which application is hereby incorporated by reference for all purposes.

### FIELD OF THE INVENTION

This invention relates to gaming systems and to gaming machines through which players may participate in wagering games, and in particular gaming machines including games with continuation features.

### BACKGROUND

Many different types of gaming machines have been developed to provide various formats and graphic presentations for conducting games and presenting game results. For example, numerous mechanical reel-type gaming machines, also known as slot machines, have been developed with different reel configurations, reel symbols, and paylines. More recently, gaming machines have been developed with video monitors that are used to produce simulations of mechanical spinning reels. These video-based gaming machines may use one or more video monitors to provide a wide variety of graphic effects in addition to simulated spinning reels, and may also provide secondary/bonus games using different reel arrangements or entirely different graphics. Many video-based gaming machines have three or five spinning reels that may be stopped to display a matrix of game symbols. The symbols displayed on the stopped reels correlate to a result of the game. Video-based gaming machines may also be used to show card games or various types of competitions such as simulated sporting competitions on which wagers may be placed. A popular use of wagering games is simulated wagering in which money is never involved, and instead points or simulated currency are wagered. Many “virtual casino” websites and smartphone apps employ such a scheme in addition to or instead of money wagering.

A typical reel-based slot machine game includes a number of paylines defined through symbol locations on a reel. Numerous variations are used to improve the prize variability and player enjoyment associated with such payline games. However, game manufacturers are continuously pressed to develop new game presentations, formats, and game graphics in an attempt to provide high entertainment value for players and thereby attract and keep players.

### SUMMARY OF THE INVENTION

A gaming machine along with a method, and program product are disclosed for operating the gaming machine. A gaming interface is displayed including an animated game element, a start button, and a claim prize button in a deactivated state. An initial game round has a first small chance of a total loss and a second larger chance of an increase in credits, conducting the initial game round, and displaying a result of the initial game round including a total credit prize. Responsive to the initial game round resulting in an increase in credits, the start button is changed to a continuation button, and the claim prize button is activated. The present invention encompasses methods for controlling wagering games, gaming machines, and computer programs that provide multiple gaming modes are coordinated with graphic presentations to vary the playing experience.

According to a first aspect of the invention, a gaming machine includes a display system, an audio device, a player input device, and at least one electronic controller operatively coupled to the display system, the audio device, and the player input device and configured to execute instructions related to a game. Tangible, non-transitory, electronically accessible memory is coupled to the at least one electronic controller and contains program code executable by the at least one electronic controller for performing a method. The method includes causing the display system to display a gaming interface including an animated game element, a start button, and a claim prize button in a deactivated state. Responsive to a player actuation of the start button, the method includes entering a designated number of player credits in a randomly determined initial game round having a first small chance of a total loss and a second larger chance of an increase in credits, conducting the initial game round, and displaying a result of the initial game round including a total credit prize. Responsive to the initial game round resulting in an increase in credits, the method includes reconfiguring the start button to a continuation button, and activating the claim prize button. Responsive to a player actuation of the claim prize button, the method includes awarding the displayed total credit prize. Responsive to a player actuation of the continue button, the method includes entering the player in a continuation game round in which the total credit prize is risked and no further player credits are risked, the continuation game round having the first small chance of a total loss and the second larger chance of an increase in credits, conducting the continuation game round, and displaying a result of the continuation game round including a new total credit prize.

Another aspect of the invention is a computer program stored on one or more non-transitory computer readable medium. The software version is, of course, typically designed to be executed by a gaming machine or networked gaming system. The software includes multiple portions of computer executable code referred to as program code. Gaming results are provided in response to activations and displayed by display program code. The program also has game controller program code for determining game play results involving operating the gaming machine according to the methods above.

Another aspect of the invention is a gaming system that includes one or more gaming servers, and a group of electronic gaming machines connected to the servers by a network, programmed to provide one of more of the methods described herein. The various functionality described herein may be distributed between the electronic gaming machines and the gaming servers in any practically functional way. For example, the current preferred architecture is for the servers to determine all aspects of game logic, random number generation, and prize awards. The gaming machines provide functionality of interfacing with the player and animating the game results to present the results received from the server in an entertaining manner. However, other embodiments of course might use a thin client architecture in which the animation is also conducted by the server and electronic gaming machines serve merely as a terminal to receive button or touchscreen input from the player and to display graphics received from the server.

Different features may be included in different versions of the invention. These and other advantages and features of the invention will be apparent from the following description of the preferred embodiments, considered along with the accompanying drawings.

### BRIEF DESCRIPTION OF THE DRAWINGS

FIG. 1 is a game screen diagram illustrating a base game mode showing a primary display to illustrate an example slot machine display arrangement on which wagering game results are presented in a primary display area according to some embodiments.

FIG. 2 shows a screen diagram illustrating a button panel touchscreen interface according to some embodiments.

FIGS. 3-7 a sequence of game screen diagrams illustrating progression through an example scenario of a multiple round base game according to some embodiments.

FIG. 8 shows a flow diagram of a process for operating a gaming machine according to some embodiments.

FIG. 9 shows a gaming machine that may be used to implement feature games according to some embodiments.

FIG. 10 is a block diagram showing various electronic components of the gaming machine shown in FIG. 9 together with additional gaming system components.

FIG. 11 is a system block diagram of a gaming system according to one embodiment.

### DETAILED DESCRIPTION OF EXAMPLE EMBODIMENTS

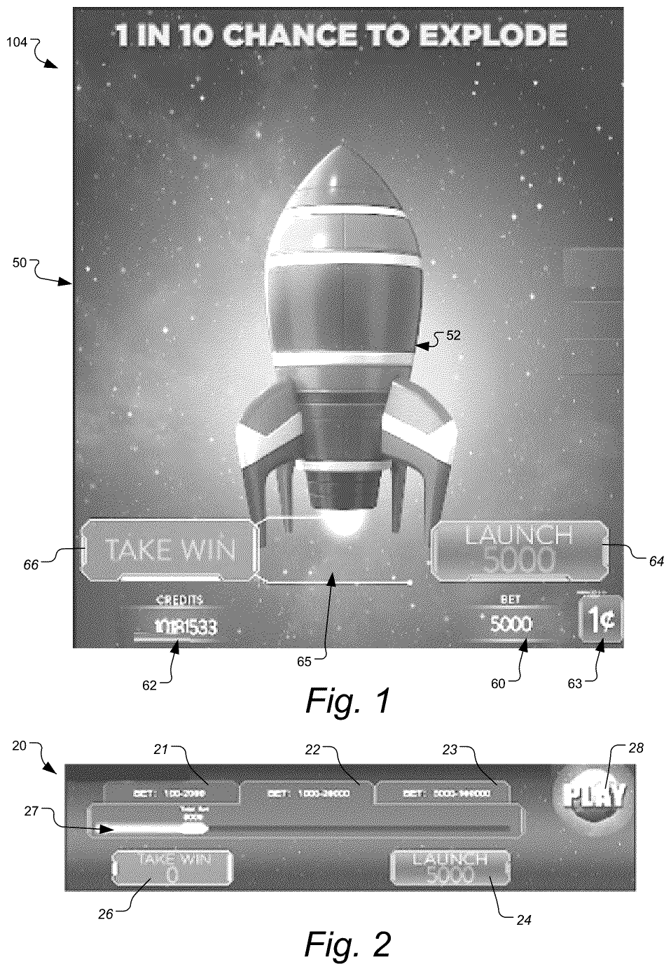

FIG. 1 is a game screen diagram illustrating a first base game mode showing a primary display 104 to illustrate an example slot machine display arrangement on which wagering game results are presented in a primary display area 50, typically found on the primary display. The primary display area 50 in the depicted mode presents an animation based game including an animated base game symbol 52, as opposed to a typical reel type game with simulated reels or another type of symbol location matrix like those of bingo, keno, or other matrix games in which multiple symbols in a matrix define game outcomes. Other embodiments may, of course, use other types of game displays to present game results.

Primary display area 50 includes two reconfigurable touchscreen buttons 64 and 66. Reconfigurable touchscreen button 64 at the beginning of a game round is a play button labelled “LAUNCH”, which enters a designated number of player credits in a bet to start a round of the base game. Reconfigurable touchscreen button 64 may be reconfigured after a game play is activated by the player to function as a continuation button, as further described below. Reconfigurable button 66 is a game functionality button which the player can activate to claim a current prize in the depicted base game. Reconfigurable button 66 is shown labelled “TAKE WIN”, and begins a game round in a greyed-out or inactive form. Reconfigurable button 66 is activated if a prize is available to be claimed as a result of the base game state, as further described below. To the right of this is win box 65, which displays the player's last awarded winnings.

Animated base game symbol 52 in this embodiment is an animated rocket, which animates with various graphic sequences to present game results such as a total loss (animated as the rocket exploding or failing), a winning initial game round (which is animated as a rocket launch), or a winning continuation game round (which is animated as the rocket being “boosted” or having a propulsion boost). Bonus prize awards associated with winning game rounds are also animated to show a boost and may be animated to show the rocket travelling and changing direction.

Below the primary display area 50 is box 60, which displays the current wager and amount bet per payline. Other versions may not have a designated bet per line. To the left of box 60 is box 62, which displays the current credits in the player's account. The wager credit denomination is shown in box 63, which may reflect monetary value credits or non-monetary value credits such as player points.

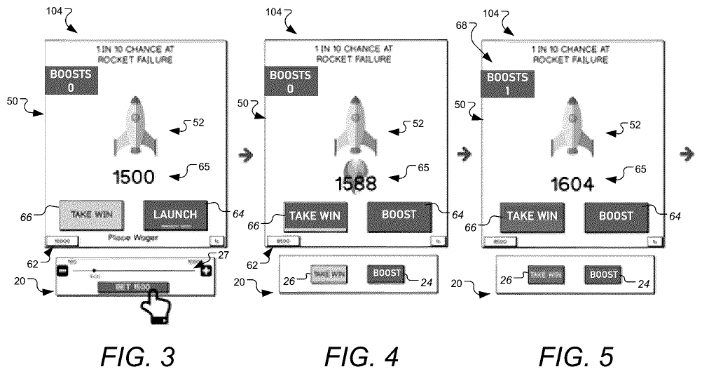

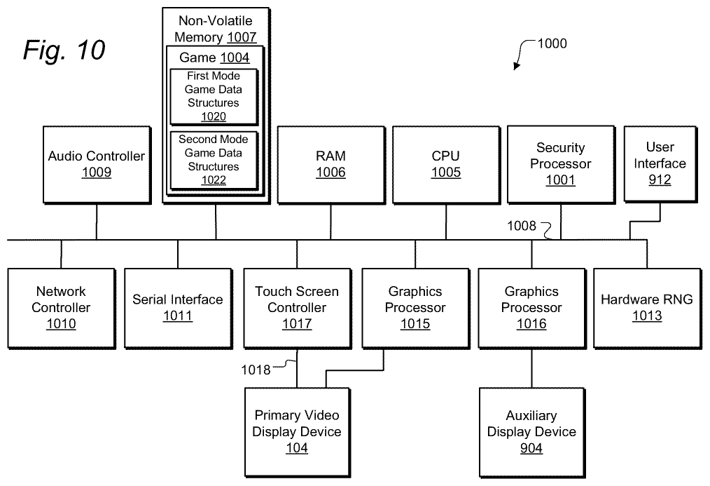

FIG. 2 shows a control screen diagram illustrating a button panel touchscreen interface 20 according to some embodiments. The depicted touchscreen interface is suitable for use with a touchscreen on a gaming cabinet button deck such as lower auxiliary display device 904 (FIG. 10). Touchscreen interface 20 includes three bet level tabs 21, 22, and 23 which enable selection of different ranges of bet levels in credits, such as the depicted bet levels of “100-2000”, “1000-20000”, and “5000-100000”. The tabs are configurable by the game operator to provide ranges of bets convenient for particular credit denominations and for the desired target market of the game, for example, “penny slots” wager levels or “high roller” wager levels. Below the tabs is a selection slider 27 which allows selecting a bet level within the range provided by the tab, for example the depicted 5000 credit bet level. The slider operates with a touchscreen input. A prize claim button 26 mirrors the function of button 66, and is made active in the same conditions. A start button 24 mirrors the function of button 64, and is reconfigured similarly to button 64 from “LAUNCH” to “BOOST”. A play button 28 serves to activate a base game and may also be reconfigured to map to a continuation button function identical to that of button 64 when it is reconfigured as discussed above. The play button 28 may be required to be consistently present on the interface in certain jurisdictions, and may be remapped without changing its graphic appearance.

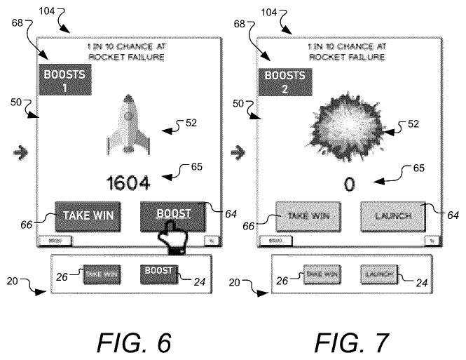

FIGS. 3-7 a sequence of game screen diagrams illustrating progression through an example scenario of a multiple round base game according to some embodiments. Each diagram shows primary display area 104 and touchscreen interface 20, which are presented on separate display devices in most embodiments. As shown by the overlay of hand on the diagram of FIG. 3, in the game state of FIG. 3, slider 27 has been used to select a bet level of 1500 and the game state is ready to receive a game activation and begin play.

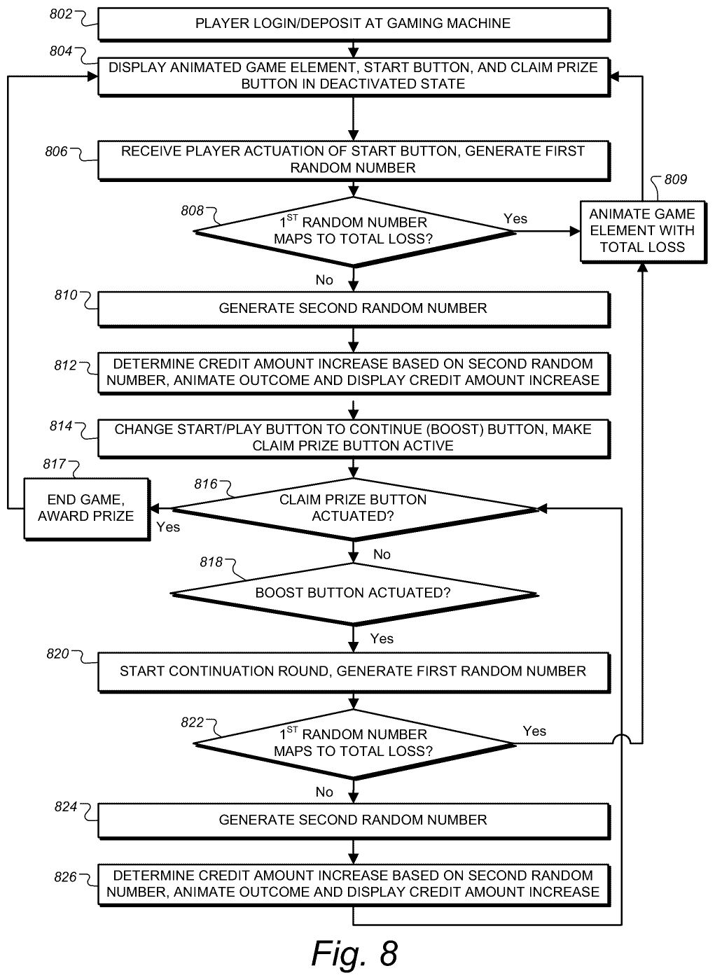

FIG. 8 shows a flow diagram of a process for operating a gaming machine according to some embodiments. The process is conducted under control of electronic processors in the gaming machine, and may include interactions with networked servers as further described below. The process is suitable for use with a gaming machine as described herein, or other suitable gaming machines. The process will now be described with reference to FIG. 8 and FIGS. 3-7.

Generally, the process is performed responsive to player inputs entered through player input devices of the gaming machines and under control of a processing system of the gaming machine. The process beings at block 802 where a player logs into a gaming machine or makes a credit deposit to establish a credit balance at the gaming machine. In the case of monetary value credits, block 802 includes receiving the player deposit through a credit input device such as a bill/voucher acceptor, and in response activating a credit meter value that establishes a player credit balance. In the case of non-monetary credits such as player points, a login or a voucher may be used.

To begin a game play, at block 804 the gaming machine is in a state in which the display system displays a gaming interface including an animated game element, a start button with the “LAUNCH” label, and a claim prize button (66, 26) with the “TAKE WIN” label and in a deactivated state. An example of this game state is shown in FIG. 1. Responsive to a player actuation of the start button in any of the forms discussed, the process from blocks 806 to 814 generally includes entering a designated number of player credits from the player's credit balance in a randomly determined initial game round having a first small chance of a total loss and a second larger chance of an increase in credits, conducting the initial game round, and displaying a result of the initial game round including a total credit prize.

At block 806, the process receives a wager activation on a player input device at the gaming machine. For the first game activation, this input may include some input from the player to set the amount to be wagered from their credit amount on the machine and activate a game round using the set wager amount. The wager amount may also be carried over from previous base game rounds by simply starting the game with the previous wager amount set. A player may adjust the default bet level using slider 27 and tabs 21, 22, and 23 at this point. The wager activation typically happens through the start button (910, FIG. 10) on the game cabinet or the reconfigurable buttons 64/24, which at this point are labeled “LAUNCH” and configured to start a base game round activation. The wager activation serves to place the wager and start a single round of game play in the base game. Responsive to the input, the process generates a first random number based on which an initial round base game outcome is selected or determined.

In this embodiment, the initial round has a first chance of ending with a total loss based on the first random number. For example, as shown in FIG. 1, before the launch it is announced that the rocket has a “1 in 10” chance of failure. At block 808, the process determines if the first random number is mapped to a total loss. If so, the process goes to block 809 where it animates the game element showing a total loss, in this embodiment showing the rocket attempting to launch and failing, resulting in a crash or an explosion. The process then returns to block 804 to start a new base game round based on a new base game player activation.

If at block 808 the first random number does not result in a total loss, the process goes to block 810, where it generates a second random number and then determines a credit amount increase to provide responsive to the initial game round resulting in an increase in credits at block 812. The second random number may be mapped to distribution of outcomes including prizes and bonus prizes. Achieving a bonus prize based on the second random number may cause the animated gaming element 52 to activate a bonus display to accompany the increase in prize amount won shown in prize box 65. Next at block 814, the process reconfigures or changes the start button to a continuation button, and activates the claim prize button. This reconfiguration enters a second base game mode in which the activate buttons do not cause credits to be taken from the player credit balance, and instead risk only the award achieved so far in the base game. FIG. 4 shows a game state after step 814 is complete, in which a credit amount increase of 88 credits has been added to the win box 65, and button 64 is reconfigured to a continue button labelled “BOOST”, and the continuation button 66, labelled “TAKE WIN” is made active.

Then at block 816, the player can choose to claim the prize by actuating claim prize button 66. If so, the process goes to block 817, where the currently displayed prize is awarded. If not, the process goes to block 818 where, responsive to a player actuation of the continue button, it enters the player in a continuation game round starting at block 820. In each continuation game round, no further credits are removed from the player's credit balance, instead the total displayed in the win box 65 is risked in the continuation round. The total credits risked includes all prior prizes and bonus prizes following the activation of the start button to enter the base game round at block 804.

At block 820, the process again generates a first random number to determine whether a total loss occurs. If so, the process at block 822 goes to block 809. If not, the process at block 824 again generates a second random number and determines a credit increase amount based on the second random number at block 826. Preferably, the continuation game round has the first small chance of a total loss (1 out of 10 chance in this embodiment) and the second larger chance of an increase in credits (9 out of 10 chance in this embodiment). In other embodiments, the chances may be altered between any respective pair of game rounds. At block 826 the process displays a result of the continuation game round including a new total credit prize, and returns to block 816. In this embodiment, the state after a single continuation round, referred to as a “BOOST”, is shown in FIG. 5. This embodiment includes a boost counter box 68, which shows the current number of boosts that the player has successfully completed in the current base game round. In some embodiments, a “Record Boosts” box may also be included, showing the maximum number of boosts ever achieved by a player on the current machine, or in an associated group of machines.

FIG. 6 and FIG. 7 depict an example scenario following the game state FIG. 5 in which a player again chooses to actuate the continuation button 64 rather than claiming their prize, and the second boost results in the total loss outcome. This provides an animation of gaming element 52 being destroyed, the prize box 65 showing a “0” to reflect the loss, and the buttons 64, 66, 24, and 26 being reconfigured to their original state for starting a new base game round.

Preferably, the process offers continuation game rounds as depicted until a total loss occurs. In some embodiments, however, the odds of a total loss may be increased as the number of continuation game rounds goes up. In some embodiments, a cap may be placed on the total number of continuation rounds offered.

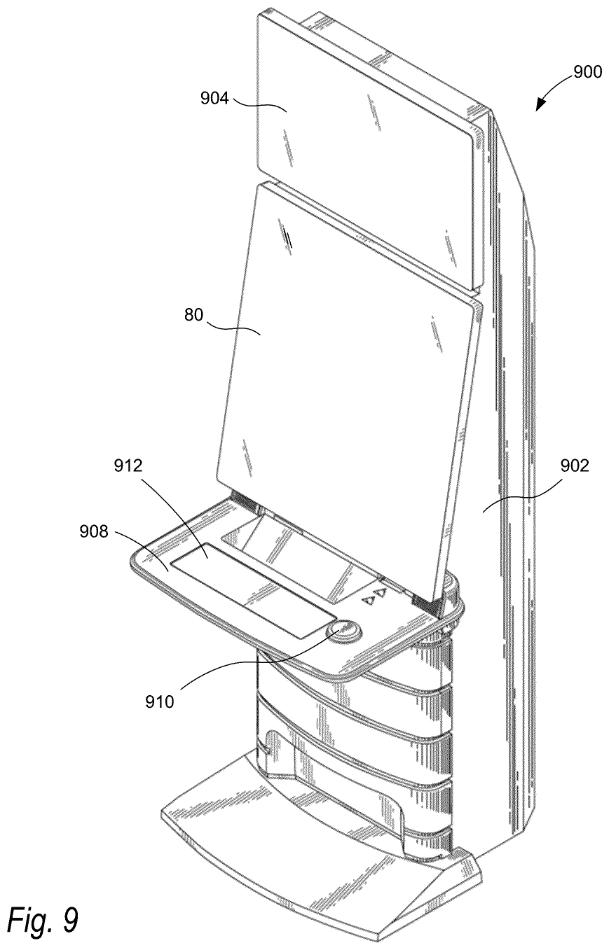

FIG. 9 is a perspective view of a gaming machine 900 which is suitable for implementing the base game continuation features described herein. Gaming machine 900 includes a cabinet 902 that houses various elements of the gaming machine. A front side of cabinet 902 supports an upper display device 904 and a lower display device 80. The front side of cabinet 902 also supports a button deck 908 that contains various player controls and interface devices including play button 910 and a touch screen button panel providing a user interface 912. In some embodiments, a “PLAY” button of buttons 910 is reconfigured during game play similarly to act as a start button and, following winning rounds in the base game, to act as a continuation button as described above with respect to reconfigurable touchscreen button 64.

As can be understood, in this embodiment, lower display device 80 provides primary game display 104, and upper display device 904 provides an auxiliary display.

It will be appreciated that gaming machines may also include a number of other player interface devices in addition to devices that are considered player controls for use in entering inputs in the course of a particular game. For example, gaming machine 900 may include a currency/voucher acceptor, a voucher/receipt printer having a voucher/receipt printer, and a player card reader although these elements are not called out in FIG. 9. Numerous other types of player interface devices may be included in gaming machines that may be used to implement embodiments of the present invention.

FIG. 10 shows a hardware and logical block diagram of gaming machine 1000 which includes a central processing unit (CPU) 1005 along with random access memory 1006 and nonvolatile memory or storage device 1007. The depicted design is suitable for implementing a gaming machine 900 (FIG. 9) or other similar gaming machines including the base game continuation processes described herein. Gaming machine 1000 may embody a special purpose gaming machine including a hardware configuration approved by a regulatory gaming authority for use in casino gaming. Examples of such gaming authorities include the National Indian Gaming Commission (NIGC), the Arizona Department of Gaming, the California Bureau of Gambling Control, the California Gambling Control Commission, the Delaware Division of Gaming Enforcement, the Illinois Gaming Board, the Michigan Gaming Control Board, the Minnesota Alcohol and Gambling Enforcement Division, the Missouri Gaming Commission, the Nevada Gaming Commission, the Nevada Gaming Control Board, the New Jersey Casino Control Commission, the New Jersey Division of Gaming Enforcement, the New York State Gaming Commission, the Ohio Casino Control Commission, the Pennsylvania Gaming Control Board, the South Dakota Commission on Gaming, the Washington State Gambling Commission, and the West Virginia Lottery. Other similar non-U.S. gaming commissions may also approve such special purpose hardware.

The depicted devices are connected on a system bus 1008 with an audio controller 1009, a network controller 1010, and a serial interface 1011. A graphics processor 1015 is also connected on system bus 1008 and is connected to drive primary video display device 80 (mounted in cabinet 902 as shown in FIG. 9). A second graphics processor 1016 is also connected on system bus 1008 in this example to drive the auxiliary display device 904. Gaming machine 1000 also includes a touch screen controller 1017 connected to system bus 1008. Touch screen controller 1017 is also connected via signal path 1018 to receive signals from a touchscreen element associated with primary video display device 80. It will be appreciated that the touchscreen element itself typically comprises a thin film that is secured over the display surface of primary video display device 80. The touchscreen element itself is not illustrated or referenced separately in the figures, and is not used in some embodiments.

Those familiar with data processing devices and systems will appreciate that other common electronic components will be included in gaming machine 1000 such as a power supply, cooling systems for the various system components, audio amplifiers, and other devices that are common in gaming machines. These additional devices are omitted from the drawings so as not to obscure the present invention in unnecessary detail.

Generally, the hardware elements shown in FIG. 10 are known elements used in the gaming machine industry. These elements are preferably mounted in a computer chassis which is housed in cabinet 902 shown in FIG. 9. Alternatively, the various electronic components may be mounted on one or more circuit boards or modules housed within cabinet 902 without a separate enclosure. Those familiar with data processing systems and the various data processing elements shown in FIG. 10 will appreciate that many variations on this illustrated structure may be used within the scope of the present invention. For example, since serial communications are commonly employed to communicate with a touch screen controller such as touch screen controller 1017, the touch screen controller may not be connected on system bus 1008, but instead include a serial communications line to serial interface 1011, which may be a USB controller or a IEEE 1394 controller for example. It will also be appreciated that some of the devices shown in FIG. 10 as being connected directly on system bus 1008 may in fact communicate with the other system components through a suitable expansion bus. Audio controller 1009, for example, may be connected to the system via a PCI bus. System bus 1008 is shown in FIG. 10 merely to indicate that the various components are connected in some fashion for communication with game processor/CPU 1005 and is not intended to limit the invention to any particular bus architecture. Numerous other variations in the gaming machine internal structure and system may be used without departing from the principles of the present invention.

Although separate graphics processor 1015 is shown for controlling primary video display device 80, and graphics processor 1016 is shown for controlling both auxiliary display device 904, it will be appreciated that game processor/CPU 1005 may control all of the display devices directly without any intermediate graphics processor. The invention is not limited to any particular arrangement of processing devices for controlling the video display device included with gaming machine 1000. Also, a gaming machine implementing the present invention is not limited to any particular number of video display devices or other types of display devices.

In the illustrated gaming machine 1000, game processor/CPU 1005 executes software which ultimately controls the entire gaming machine including the receipt of player inputs and the presentation of the graphic symbols displayed according to the invention through the display devices 80 and 904 associated with the gaming machine. As will be discussed further below, game processor/CPU 1005 either alone or in combination with graphics processor 1015 may implement a presentation controller for performing functions associated with a primary game that may be available through the gaming machine, and may also implement a game client for directing one or more display devices at the gaming machine to display the feature game mode according to the present invention. Game processor/CPU 1005 also executes software related to communications handled through network controller 1010, and software related to various peripheral devices such as those connected to the system through audio controller 1009, serial interface 1011, and touch screen controller 1017. Game processor/CPU 1005 may also execute software to perform accounting functions associated with game play. Random access memory 1006 provides memory for use by game processor/CPU 1005 in executing its various software programs, while the nonvolatile memory or storage device 1007 may comprise a hard drive or other mass storage device providing storage for programs not in use or for other data generated or used in the course of gaming machine operation. Network controller 1010 provides an interface to other components of a gaming system in which gaming machine 1000 is included.

Security processor 1001 is a special purpose microprocessor or processor core which acts to control the boot process of gaming machine 1000 and verify that various firmware and software modules thereon match those approved by the appropriate regulators for modules requiring regulatory verification before the modules are loaded. Security processor 1001 may perform various cryptographic verification procedures to verify such firmware and software modules, including maintaining keys, accessing a key verification authority, and maintaining and checking digital signatures. Security processor 1001 may be a separate processor connected on system bus 1008 as depicted, or may be embodied as a processing core within CPU 1005. Security processor 1001 may also operate to verify a special purpose ROM of Flash memory device containing binary files regulated by the relevant gaming regulator and installed in the gaming machine to update gaming software or firmware. In some embodiments, such a ROM or Flash may be installed in the gaming machine.

It should be noted that the invention is not limited to gaming machines employing the arrangement of processing devices and interfaces shown in example gaming machine 1000. Other gaming machines through which the features herein are implemented may include one or more special purpose processing devices to perform the various processing steps for implementing the present invention, such as generating random numbers or checking the security status of software packages or gaming credit vouchers. For example, security processor 1001 may include such a special purpose device for checking the security status of software packages on gaming machine 1000 before allowing the machine to boot, in order to verify compliance with regulations from a regulatory authority as discussed above. Unlike processing devices such as game processor/CPU 1005, these special purpose processing devices may not employ operational program code to direct the various processing steps.

Still referring to FIG. 10 showing an example design for a gaming machine 1000, the depicted machine in operation is controlled generally by game processor/CPU 1005 which stores operating programs and data in non-volatile memory or storage device 1007 with game software module 1004, and software or drivers for user interface 912, network controller 1010, audio/visual controllers, and a hardware random number generator (RNG) 1013, which is employed if software RNG procedures are not allowed in a particular gaming jurisdiction. Either hardware RNG 1013 or a suitable software RNG are employed for making the random selections of game outcomes, reel stop positions, etc. when operating the game as described herein.

The game software module 1004, once installed, also is held in non-volatile memory of the gaming machine, preferably a separate flash drive or hard drive from the memory holding the gaming machine operating system. CPU or game processor/CPU 1005 may comprise a conventional microprocessor, such as an Intel microprocessor, mounted on a printed circuit board with supporting ports, drivers, memory, software, and firmware to communicate with and control gaming machine operations, such as through the execution of code stored in non-volatile memory or storage device 1007. Such executed code includes game software engine 1004 for executing the base game. Game software engine 1004 accesses data structures 1020 and 1022 such as media assets, paytables and math algorithms for providing gaming results. Data structures 1020 provide data for operating the base game in the first mode in which a credit allocation is made for the initial game round, while a different set of data structures provide data for operating the base game in the second mode providing the subsequent game rounds activated by the continuation button. Such data structures may include a different paytable for each of the modes. Non-volatile memory of storage device 1007 also holds group gaming messaging plugin software or firmware 1032, which is executed by CPU 1005 to perform the processes and techniques described herein for providing control of the gaming machine display and audio system to the group controller for presenting the base game process herein, for example the process of FIG. 8. Game processor/CPU 1005 connects to user interface 912 such that a player may enter input information, and game processor/CPU 1005 may respond according to its programming, such as to apply a wager and initiate execution of a game.

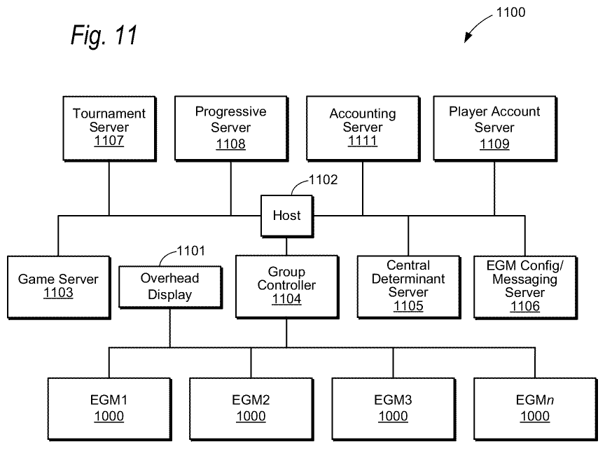

Game processor/CPU 1005 also may connect through network controller 1010 to a gaming network, such as example casino server network 1100 shown in FIG. 11.

Referring now to FIG. 11, a networked gaming system 1100 associated with one or more gaming facilities may include one or more networked gaming machines 100 (shown in FIG. 11 as EGM1-EGMn) connected in the network by suitable network cable or wirelessly. Networked gaming machines 1000 and one or more overhead display devices 1101 may be operatively connected so that the overhead display device or display devices may mirror or replay the content of one or more displays of gaming machines 1000. For example, the display content for a given gaming machine 1000 (including a base game portion and/or bonus features) may be transmitted through network controller 1010 to a controller associated with the overhead display device(s) 1101. In the event gaming machines 1000 have cameras installed, the respective player's video images may be displayed on overhead display device 1101 along with the content of the player's gaming machine display.

The example gaming network 1100 shown in FIG. 11 includes a host server 1102 and group controller 1104, that together may function as an intermediary between floor devices such as gaming machines 1000 and back-office devices such as the various servers described below. Game server 1103 may provide server-based games and/or game services to network connected gaming devices such as gaming machines 1000. Group controller 1104 performs functions for grouping gaming machines in local groups that may participate in group presentations. Central determinant server 1105 may be included in the network to identify or select lottery, bingo, or other centrally determined game results and provide the result information to networked gaming machines 1000 that present the games or game results to players.

EGM configuration and messaging server 1106 may provide game and non-game content and operational software for use by the gaming machines 1000 in the course of providing games and while the gaming machines are unused and in an idle state. For example, server 1106 may control the distribution of game software and graphic control assets to the gaming machines as well as advertising messages and other messages that may be presented using a display device of a gaming machine 1000. EGM configuration and messaging server 1106 may also be used to direct candle control software to gaming machines 1000 that include a system in accordance with aspects of the present invention.

Tournament server 1107 may be included in the system for controlling or coordinating tournament functions. These functions may include maintaining tournament player scores and ranking during the course of tournament play, and communicating this information to the various gaming machines 1000 participating in the tournament. Tournament server 1107 may also function to enroll players in tournaments, schedule tournaments, and maintain the time remaining in the various tournaments.

Progressive server 1108 may maintain progressive pools for progressive games that may be available through the various gaming machines 1000, including the group jackpot awards described herein. In some implementations, progressive server 1108 may simply receive communications indicating contribution amounts that have been determined by processes executing at the various gaming machines 1000 or elsewhere in the gaming network. Alternatively, progressive server 1108 may perform processes to determine the contribution amounts for incrementing the various progressive pools that may be maintained. Progressive server 1108 may also periodically communicate current pool values back to the various gaming machines 1000 and may participate in communicating awarded progressive prize amounts to the gaming machines and in adjusting the progressive prize pools accordingly. In some implementations, progressive server 1108 may also determine or participate in determining when a progressive prize triggering event occurs.

Accounting server 1111 may receive gaming data from each of the networked gaming devices, perform audit functions, and provide data for analysis programs. Player account server 1109 may maintain player account records, and store persistent player data such as accumulated player points and/or player preferences (for example, game personalizing selections or options).

Gaming network 1100 illustrated in FIG. 11 is provided merely as an example of a gaming network that may include gaming machines with candle systems according to aspects of the present invention and is not intended to be limiting in any way. Gaming machines controlled according to aspects of the present invention are not limited to use with gaming networks such as network 1100.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

In the above descriptions and the following claims, terms such as top, bottom, upper, lower, and the like with reference to a given feature are intended only to identify a given feature and distinguish that feature from other features. Unless specifically stated otherwise, such terms are not intended to convey any spatial or temporal relationship for the feature relative to any other feature.

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements that does not have the defined characteristic or feature.

The above-described representative embodiments are intended to illustrate the principles of the invention, but not to limit the scope of the invention. Various other embodiments and modifications to these representative embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

1. A gaming machine comprising:
a display system, an audio device, a player input device, and at least one electronic controller operatively coupled to the display system, the audio device, and the player input device and configured to execute instructions related to a game; and
tangible, non-transitory electronically accessible memory coupled to the at least one electronic controller and containing program code executable by the at least one electronic controller for:
causing the display system to display a gaming interface including an animated game element, a start button, and a claim prize button in a deactivated state;
responsive to a player actuation of the start button, entering a designated number of player credits in an initial game round having a first small chance of a total loss and a second larger chance of an increase in credits, conducting the initial game round, and displaying a result of the initial game round including a total credit prize;
responsive to the initial game round resulting in an increase in credits, reconfiguring the start button to a continuation button, and activating the claim prize button;
responsive to a player actuation of the claim prize button, awarding the displayed total credit prize; and
responsive to a player actuation of the continue button, conducting a continuation game round in which the total credit prize is risked and no further player credits are risked, the continuation game round having the first small chance of a total loss and the second larger chance of an increase in credits, conducting the continuation game round, and displaying a result of the continuation game round including a new total credit prize.

2. The gaming machine of claim 1 wherein the program code is further operable for offering continuation game rounds until a total loss occurs.

3. The gaming machine of claim 2 wherein the initial game round is conducted by generating a first random number based upon which it is determined whether a total loss occurs, and, if a total loss does not occur, generating a second random number based upon which a credit increase amount is determined.

4. The gaming machine of claim 3 wherein each continuation game round is conducted by generating a first random number based upon which it is determined whether a total loss occurs, and, if a total loss does not occur, generating a second random number based upon which a credit increase amount is determined.

5. The gaming machine of claim 1 wherein the player input device includes a second touchscreen display located on a button panel of the gaming machine, and wherein the start button and claim prize button are reproduced on the second touchscreen display.

6. The gaming machine of claim 1 wherein the animated game element is an animated rocket, and a total loss outcome is displayed as the animated rocket exploding.

7. The gaming machine of claim 1 wherein the program code is further executable for displaying a number of continuation rounds achieved.

8. The gaming machine of claim 1 wherein the program code is further executable for displaying a record number of continuation rounds achieved.

9. A method for controlling operation of a gaming machine, the method comprising:
in response to a play input entered through a player input device of the gaming machine and under control of a processing system of the gaming machine executing program code, causing a display system of the gaming machine to display a gaming interface including an animated game element, a start button, and a claim prize button in a deactivated state;
responsive to a player actuation of the start button, entering a designated number of player credits in a initial game round having a first small chance of a total loss and a second larger chance of an increase in credits, conducting the initial game round, and displaying a result of the initial game round including a total credit prize;
responsive to the initial game round resulting in an increase in credits, reconfiguring the start button to a continuation button, and activating the claim prize button;
responsive to a player actuation of the claim prize button, awarding the displayed total credit prize; and
responsive to a player actuation of the continue button, conducting a continuation game round in which the total credit prize is risked and no further player credits are risked, the continuation game round having the first small chance of a total loss and the second larger chance of an increase in credits, conducting the continuation game round, and displaying a result of the continuation game round including a new total credit prize.

10. The method of claim 9 wherein the program code is further operable for offering continuation game rounds until a total loss occurs.

11. The method of claim 9 wherein the initial game round is conducted by generating a first random number based upon which it is determined whether a total loss occurs, and, if a total loss does not occur, generating a second random number based upon which a credit increase amount is determined.

12. The method of claim 11 wherein each continuation game round is conducted by generating a first random number based upon which it is determined whether a total loss occurs, and, if a total loss does not occur, generating a second random number based upon which a credit increase amount is determined.

13. The method of claim 9 wherein the player input device includes a second touchscreen display located on a button panel of the gaming machine, and the method includes reproducing the the start button and claim prize button on the second touchscreen display.

14. The method of claim 9 the animated game element is an animated rocket, and a total loss outcome is displayed as the animated rocket exploding.

15. The method of claim 9 wherein the program code is further executable for displaying a number of continuation rounds achieved.

16. The method of claim 9 wherein the program code is further executable for displaying a record number of continuation rounds achieved.

17. A tangible, non-transitory computer readable media holding a program product for execution by one or more electronic controllers of a gaming machine, the program product including machine instruction program code for:
causing a display system of the gaming machine to display a gaming interface including an animated game element, a start button, and a claim prize button in a deactivated state;
responsive to a player actuation of the start button, entering a designated number of player credits in an initial game round having a first small chance of a total loss and a second larger chance of an increase in credits, conducting the initial game round, and displaying a result of the initial game round including a total credit prize;
responsive to the initial game round resulting in an increase in credits, reconfiguring the start button to a continuation button, and activating the claim prize button;
responsive to a player actuation of the claim prize button, awarding the displayed total credit prize; and
responsive to a player actuation of the continue button, conducting a continuation game round in which the total credit prize is risked and no further player credits are risked, the continuation game round having the first small chance of a total loss and the second larger chance of an increase in credits, conducting the continuation game round, and displaying a result of the continuation game round including a new total credit prize.

18. The tangible, non-transitory computer readable media holding a program product of claim 17 wherein:
the initial game round is conducted by generating a first random number based upon which it is determined whether a total loss occurs, and, if a total loss does not occur, generating a second random number based upon which a credit increase amount is determined.

19. The tangible, non-transitory computer readable media holding a program product of claim 17 wherein:
each continuation game round is conducted by generating a first random number based upon which it is determined whether a total loss occurs, and, if a total loss does not occur, generating a second random number based upon which a credit increase amount is determined.
